(19) United States
(12) Patent Application Publication
(10) Pub. No.: US 2026/0192750 A1
(43) Pub. Date: Jul. 9, 2026

(54) VEHICLE PILLAR DISPLAY SYSTEM

(71) Applicant: Harman International Industries, Incorporated, Stamford, CT (US)

(72) Inventors: Peter Brandt, Pfinztal (DE); Joerg Welke, Ettlingen-Schöllbronn (DE); Ramazan Ferhat Ölgün, Munich (DE)

(21) Appl. No.: 19/121,938

(22) PCT Filed: Oct. 9, 2022
(86) PCT No.: PCT/US2022/047152

§ 371 Date: Apr. 17, 2025

(51) Int. Cl. B60R 1/24; B60K 35/22; G06F 3/14; G06V 10/764; G06V 20/59; G06V 40/20

(52) U.S. Cl. CPC B60R 1/24; B60K 35/223; G06F 3/14; G06V 20/597; G06V 40/20; B60K 2360/182; B60K 2360/21; B60K 2360/332; B60K 2360/788; B60R 2300/10; B60R 2300/20; B60R 2300/802; G06V 10/764

(57) ABSTRACT

A display system arranged on a vehicle pillar may include a flexible display arranged on a portion of a pillar of a vehicle, the display including a microLED display having a plurality of micron LED chips allowing the display to be flexible, and the display configured to receive and display images from at least one camera configured to acquire images from an exterior of the vehicle to provide a line of sight through the pillar via the display.

### TECHNICAL FIELD

Disclosed herein are systems and methods for a display system on a vehicle pillar.

### BACKGROUND

Vehicle structures often create blind spots. For example, pillars such as A-pillars may block a driver's view from certain angles. This may be becoming more of an issue where the size of pillars are increasing, further reducing the driver's field of view. While some vehicles may include blind spot information systems (BLIS), such systems simply alert the driver as to the presence of an object, without rendering further information.

### SUMMARY

A display system arranged on a vehicle pillar may include a flexible display arranged on a portion of a pillar of a vehicle, the display including a microLED display having a plurality of micron LED chips allowing the display to be flexible, and the display configured to receive and display images from at least one camera configured to acquire images from an exterior of the vehicle to provide a line of sight through the pillar via the display.

A vehicle having a camera and display system may include a transparent display forming a portion of a pillar of a vehicle, the display including a plurality of micron LED chips mounted on a matrix allowing the display to be flexible and transparent and creating a visible line of sight through the portion of the pillar; and at least one interior camera arranged behind the flexible display to acquire images of an interior of the vehicle, where the at least one camera is capable of acquiring images through the flexible display.

### BRIEF DESCRIPTION OF THE DRAWINGS

These and/or other features, aspects and advantages of the present disclosure will be better understood after reading the following detailed description with reference to the drawings. Throughout these drawings, the same numeral references represent the same components, where:

FIG. 1 illustrates an example vehicle having a vehicle display system;

FIG. 2 illustrates an example display of the vehicle display system of FIG. 1;

FIG. 3 illustrates a perspective view of the example display of FIG. 2 arranged on a pillar of a vehicle; and

FIG. 4 illustrates an example process of the display system.

For illustrative purposes, the present disclosure has provided a description of the embodiments, but the described embodiments are not exhaustive or limited to the embodiments disclosed herein. Without departing from the scope and spirit of the described embodiments, those of ordinary skill in the art will appreciate that there are many modifications and changes.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicle frames often include several pillars that may block the field of view of drivers. With the sizes of such pillars increasing, the field of view is further blocked, causing blind spots that prevent drivers from seeing oncoming objects such as pedestrians, cyclists, etc. To aid with this, displays may be arranged throughout the vehicle to provide images showing the environment outside of the vehicle. In the system described herein, a three dimensional, folded display having micro LEDs may be arranged on a vehicle pillar. Such display may be configured to provide images generated by exterior cameras to mimic the environment outside of the vehicle. This allows vehicle occupants to have a line of sight through the pillar, which decreases blind spots, etc.

Further, In addition to being flexible, the display be may generally transparent. A camera may be arranged behind the display and within the pillar. By the display forming a transparent portion of the pillar, the transparent portion of the display accommodates for the field of view of the camera. The camera may collect images of the interior of the vehicle. Such images may be used for purposes of determining whether a driver is in a distracted state.

The display may be a flexible display configured to conform to a certain shape. In the examples disclosed herein, the flexible display may wrap around a pillar, or be formed integral with the pillar. The display may be formed of a plurality of microLEDs (light emitting diodes). The microLEDs allow for the display be to be flexible and bendable. In addition to the display presenting images, information, etc., to the vehicle occupants, the display be transparent, allowing an increased field of view for the camera arranged there behind. Again, the flexible display aids to eliminate blind spots typically created by the pillar.

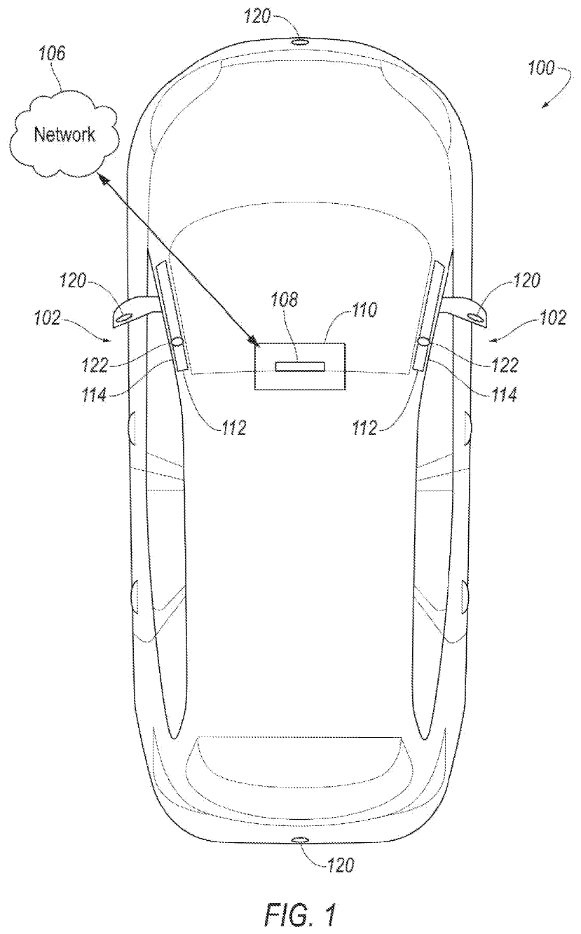

FIG. 1 illustrates an example vehicle 100 having a vehicle display system 102. The vehicle 100 may be various types of passenger vehicles, such as crossover utility vehicle (CUV), sport utility vehicle (SUV), truck, recreational vehicle (RV), boat, plane or other mobile machine for transporting people or goods. The vehicle 100 may include a vehicle frame having various support structures such as pillars, roof, doors, windows, etc. Such support structures may provide structure to the vehicle, but also create blind spots, obstructions, etc., when the vehicle is in use. In the example of FIG. 1, an A-pillar 114 is specifically labeled.

The display system 102 may be included within the vehicle 100 and may interface with a processor 110 arranged within the vehicle 100. The processor 110 may be included in the vehicle head unit, or a vehicle ECU. The processor 110 may include various vehicle systems such as navigation, infotainment, autonomous vehicle systems, etc. The processor 110 may include a display system processor configured to determine how, when and where to configure certain vehicle displays.

The processor 110 may also include a driver behavior application configured to determine a driver's state based on certain characteristics of the driver's behavior based on data received from other vehicle components such as cameras, biometric sensors, microphones, etc.

The vehicle may be a passenger vehicle that includes various seats. The vehicle 100 may include a plurality of internal infotainment devices. In general, the infotainment devices may be devices configured to present content to a user, either audibly, visually, haptically, etc., within the vehicle cabin. The infotainment devices may include a display or projector configured to visually present information.

The infotainment devices may be arranged at various locations throughout the vehicle 100, such as the vehicle head unit, back headrests, sides of the vehicle, rear of the vehicle, etc. FIG. 1 illustrates an example center display 108 at the head unit and in communication with the processor 110. Furthermore, the infotainment devices may be portable personal devices of each occupant such as the occupants'phone or tablet. The processor 110 may receive commands from passengers and provide instructions to the various infotainment devices based on those commands.

In the example of FIG. 1, one of the infotainment devices may also include a pillar display 112. The pillar display 112 may be a display arranged as part of, or on, a pillar 114 of the vehicle 100. The pillar display 112 may be arranged on one or more of the pillars 114 within the vehicle, and in the example of FIG. 1, two pillar displays 112 are illustrated, one on each of the two A-pillars. While the displays 112 are shown to be part of the A-pillar, the displays 112 may be part of other pillars, supports, doors, windows, mirrors, etc. In one example, the display may be arranged on a portion of the A-pillar facing the inside of the vehicle 102.

The display 112 may be formed of LEDs, or microLEDS allowing the display to be flexible and transparent. MicroLED displays may be made of a plurality of microns LED chips on a matrix or backplate. By using multiple LED chips, the display may be flexible, allowing the display to flex and bend. The displays are made in RGB formation.

Such displays may have the benefits of high brightness, wide color pallet, high aperture ratio, etc. The display may be borderless and also transparent or partially transparent, and require very low energy. Further, MicroLEDS may be driven by high current without overheating or wear and tear concerns. When compared to other transparent displays, MicroLEDs may provide for small pixel size all while achieving high brightness.

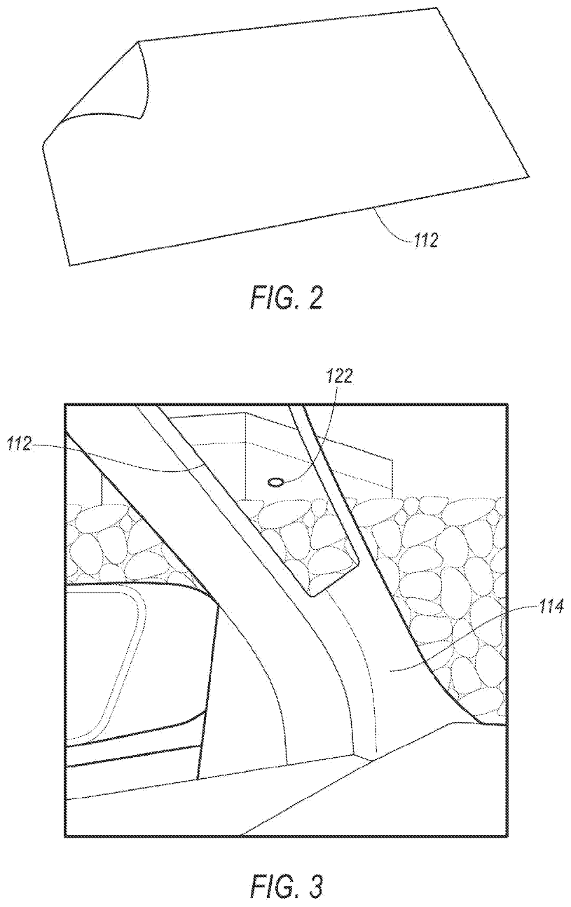

FIG. 2 illustrates an example flexible display 112 of the vehicle display system 102 of FIG. 1. Such display 112 may be borderless and flexible, so as to form to the necessary geometry of the pillar 114. The flexible display 112 may easily conform to the shape of the pillar 114 and be attached thereto.

Further, while the display 112 may be transparent and configured to allow for a line of sight therethrough, the display 112 may also be capable of displaying information, images, etc. In use, the processor 110 may instruct the display 112 to present certain screens or displays. In one example, the processor 110 may instruct the display 112 to present information such as vehicle information, infotainment, weather, climate, navigation, etc. In another example the processor 110 may instruct the display to display an image of the line of sight that would be realized as if the user were looking through the pillar 114. That is, the image displayed may be one that could be seen through the pillar 114 as if the pillar 114 were not present. This may be generated based on a stitching of images acquired from exterior vehicle cameras.

Returning to FIG. 1, the vehicle 100 may include a plurality of exterior facing cameras 120. The vehicle 100 may also include at least on interior facing camera 122. In general, the cameras 120, 122 may be a video camera, or configured to take still photos, and may be configured to capture areas inside and around the vehicle. The exterior cameras 120 may include cameras arranged on the vehicle, and be configured to capture the environment surrounding the exterior of the vehicle 102. For example, the exterior cameras 120 may be used for parking aids, birds eye views, back up cameras, etc. As explained, such exterior cameras 120 may be used to stitch together images for the interior displays (i.e., the flexible display 112 and/or the center display 108) allowing the user to visibly see portions of the environment exterior to the vehicle 100 that may not be otherwise visible to the vehicle occupants.

The exterior cameras 120 may be arranged at various winglets, such as the rear view mirrors, as well as on each of the front and rear bumpers, though other and addition placements may be appreciated.

The interior facing camera 122 may include at least one camera 122 arranged to be facing the inside of the vehicle and acquire images thereof. In the example of FIG. 1., the interior camera 122 is arranged behind the pillar display 112. In one example the interior camera may be a three dimensional camera to allow for rotation and visualization from various perspectives. In another example, the interior camera 122 may include more than one camera to generate or acquire images, each in a different plane.

The interior camera 122 may be configured to acquire images of the driver of the vehicle 100. This may in turn be used by the processor 110 to determine a state of the driver, such as alert, drowsy, distracted, etc. The interior camera 122 may be positioned within the pillar 114. Because the display 112 is transparent, the interior camera 122 may be placed behind the display 112 and directed toward the driver seat to acquire images of the driver. The camera 122 may capture images of the driver, but still be placed behind the display 112. This allows the camera 122 to be less noticeable, and take up less space within the vehicle. The interior cameras 122 may also be used to acquire biometric data such as facial images to verify persons and identities.

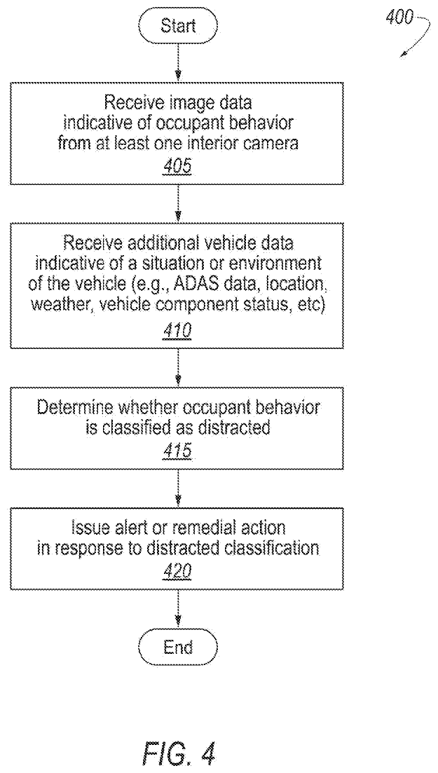

Such images acquired from the interior camera 122 may be transmitted to the processor 110 where the processor 110 may use the image data to determine the driver state. The image data may be translated by the processor 110 to indicate certain information about the driver. In one example, the image data may indicate that the driver's head is in a certain position or has a certain gaze direction. In another example, the image data, when reviewed over time, may indicate a nodding of the driver's head, or lack of movement of the driver's head as well. Based on this analysis, the processor 110 may classify the driver in terms of a driver state. This may include a distracted state. Such determination may then trigger a remedial action by the vehicle 100, such as the sounding of an alarm, haptic feedback to startle the driver, activation of certain advanced driver assistance systems (ADAS) features, etc. This process is described in more detail with respect to FIG. 4 herein.

The vehicle 100 may communicate with a remote network 106. Although not shown, the vehicle 100 may include a connected vehicle system including one or more systems facilitated via connected car or connected vehicle telematics. These systems may also include features available on a separate mobile device, usually a mobile device of the driver. The processor 110 of the vehicle 100 may communicate wirelessly with various vehicle components, as well as with mobile devices (not shown) to access data, such as an occupant's calendar, navigation system, GPS antenna, media content, etc. The data may also include dynamic data provided from external sources such as weather information, traffic information, etc. In addition to or in alternative to the connected vehicle system, the processor 110 may receive data from the network 106, other mobile devices, other vehicles, etc.

FIG. 3 illustrates a perspective view of the example display of FIG. 2 arranged on the pillar 114 of the vehicle 100. The display 112 may make up at least a portion of the facade of the pillar 114 and allow for transparency at that portion of the pillar 114. The display 112 may also allow for images to appear and refresh to provide the appearance of transparency.

The display 112 may be attached or affixed to the pillar 114 in one of many ways. In one example, the display 112 may be attached via adhesives. In another example, the display 112 may rest within a recess and ridge formed by the pillar 114. In yet another example, brackets, rails, etc., may be used to maintain the display 112 on or in the pillar 114. Due to the flexibility of the display 112, the display 112 may be easily maneuvered to fit on or within the pillar 114. Notably, a single display design may be configured to mate or work with various pillar designs, shapes and sizes, allowing such a flexible display to be widely used and installed across various vehicle makes and models.

The interior facing camera 122 may be installed behind the display 112 within the pillar 114. In the example shown in FIG. 3, the camera 122 may be centrally placed so as to maximize the field of view. However, the camera 122 may be placed anywhere behind the display due to the displays transparency.

The display 112 and the camera 122 may be powered by the vehicle battery, a separate battery, by wired or wireless power transfer, etc. In the example of a wired connection, such wires may be received within the pillar 114. The display 112 and camera 122 may also communicate with the processor 110 via wired or wireless communication.

FIG. 4 illustrates an example process 400 of the display system 102. The process 400 may begin at step 405 where the processor 110 may receive image data from the interior facing camera 122. As explained, the image data may include images of the driver.

At block 410, the processor 110 may receive additional vehicle data from other vehicle systems such as ADAS, including but not limited to braking systems, charging systems, etc. This additional vehicle data may indicate certain vehicle 100 behavior, external or environmental information (e.g., weather), etc. This data may indicate performance or give context when taken in conjunction with the image data. For example, should the driver harshly brake, and turn his head, the processor 110 may determine that the driver may have pressed the brakes to avoid an approaching object. In another example, the driver may harshly break, but the image data does not detect any movement of the driver's head, which may indicate that the driver is not paying attention. Other data may be acquired such as biometric data, indicating a user's pulse or other vital signs.

At block 415, the processor 110 may determine whether the occupant behavior indicates that of a distracted driver. The processor 110 may classify the occupant behavior based at least in part on the image data, but may also use other data such as the additional vehicle data to classify the driver behavior. The processor 110 may do this by comparing the image data with other known data, or classifying the image data and comparing such classifications with known classifications that indicate distracted or distressed drivers.

At block 420, the processor 110 may issue an alert or other remedial response in response to the distracted driver classification. This may include an alarm sounding, haptic feedback via the driver seats, etc. Other remedial responses may be activation of certain ADAS features such as autonomous driving feature, automatic braking, etc.

While the processor 110 is described as performing the features and methods herein, other processors and controllers may also be used, including remote processors, special purpose processors, etc.

Various aspects of the current embodiments may be embodied as a system, a method, or a computer program product. Therefore, various aspects of the present disclosure may take the following forms: a complete hardware embodiment, a complete software embodiment (including firmware, resident software, microcode, etc.), or a combination of software and hardware embodiments, which may be all regarded as “module” or “system” generally herein. In addition, any hardware and/or software technology, process, function, component, engine, module, or system described in the present disclosure may be implemented as a circuit or a group of circuits. In addition, various aspects of the present disclosure may take the form of a computer program product embodied in one or more computer-readable media on which computer-readable program code is embodied.

Any combination of one or more computer-readable media may be utilized. The computer-readable mediums may be a computer-readable signal medium or a computer-readable storage medium. The computer-readable storage medium may be, for example, but not limited to, an electronic, magnetic, optical, electromagnetic, infrared, or semiconductor system, device or apparatus, or any suitable combination of the foregoing. More specific examples (non-exhaustive list) of computer-readable storage media may include each of the following: an electrical connection with one or more wires, a portable computer floppy disk, a hard disk, a random access memory (RAM), a read only memory (ROM), an erasable programmable read-only memory (EPROM or flash memory), an optical fiber, a portable CD-ROM, an optical storage apparatus, a magnetic storage apparatus, or any suitable combination of the foregoing. In the context of this document, a computer-readable storage medium may be any tangible medium that can contain or store a program for use by an instruction execution system, device, or apparatus or in combination with the instruction execution system, device, or apparatus.

The aspects of the present disclosure are described above with reference to flowchart illustrations and/or block diagrams of methods, devices (systems) and computer program products according to the implementations of the present disclosure. It will be understood that each block of the flowchart illustrations and/or block diagrams and combinations of blocks in the flowchart illustrations and/or block diagrams may be implemented by computer program instructions. These computer program instructions may be provided to processors of general purpose computers, special purpose computers, or other programmable data processing devices to produce machines. When the instructions are executed via the processors of the computers or other programmable data processing devices, the functions/actions specified in the flowchart and/or block diagram block or multiple blocks can be realized. These processors m be, but are not limited to, general purpose processors, special purpose processors, special application processors, or field programmable gate arrays.

The flowcharts and block diagrams in the drawings illustrate the architecture, functionality, and operation of possible implementations of systems, methods, and computer program products according to various embodiments of the present disclosure. In this regard, each block in the flowchart or block diagram may represent a module, section, or part of code, and the code includes one or more executable instructions for implementing prescribed logical functions. It should also be noted that in some alternative implementations, the functionality described in the blocks may occur out of the order described in the drawings. For example, two blocks shown in succession may actually be executed substantially simultaneously, or the blocks may sometimes be executed in the reverse order depending on the functionality involved. It should also be noted that each block in the block diagram and/or flowchart illustration and the combination of the blocks in the block diagram and/or flowchart illustration can be implemented by a dedicated hardware-based system or dedicated hardware and computer instructions that perform the specified functions or actions.

Although the foregoing content is directed to the embodiments of the present disclosure, other and additional embodiments of the present disclosure may be conceived without departing from the basic scope of the present disclosure, and the scope of the present disclosure is determined by the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. A display system arranged on a vehicle pillar, comprising:
a flexible display arranged on a portion of a pillar of a vehicle, the display including a microLED display having a plurality of micron LED chips allowing the display to be flexible;
the display configured to receive and display images from at least one camera configured to present images from an exterior of the vehicle to provide a line of sight through the pillar via the flexible display.

2. The display system of claim 1, further comprising at least one interior camera arranged behind the flexible display and within the pillar to acquire images of an interior of the vehicle, where the at least one camera is capable of acquiring images through the flexible display.

3. The display of claim 1, wherein the flexible display is wrapped around the pillar and conforms to dimensions of the pillar.

4. The display system of claim 1, further including a controller programmed to provide instructions to the flexible display for presenting the images via the display.

5. The display system of claim 4, wherein the controller is programmed to receive image data from the least one camera, the image data indicative of driver behavior.

6. The display system of claim 5, wherein the controller is programmed to classify the driver behavior based on the image data.

7. The display system of claim 6, wherein the controller is further programmed to transmit an alert in response to the driver behavior being classified as distracted.

8. The display system of claim 6, wherein the controller is further programmed to provide a remedial action in response to the driver behavior being classified as distracted.

9. The display system of claim 1 further including at least one interior camera in the form of a three dimensional camera configured to acquire images from multiple perspectives.

10. The display system of claim 1 further including at least one interior camera in the form of at least two, two-dimensional cameras each configured to acquire images from a different plane.

11. A vehicle having a camera and display system, comprising:
a transparent display forming a portion of a pillar of a vehicle, the display including a plurality of micron LED chips mounted on a matrix allowing the display to be flexible and transparent and creating a visible line of sight through the portion of the pillar; and
at least one interior camera arranged behind the transparent display to acquire images of an interior of the vehicle, where the at least one interior camera is capable of acquiring images through the transparent display.

12. The display system of claim 11, wherein the transparent display is arranged on the pillar and conforms to dimensions of the pillar.

13. The display system of claim 11, wherein the transparent display is configured to be attached to a portion of a vehicle A-pillar.

14. The display system of claim 11, further including a controller programmed to provide instructions to the transparent display for presenting information via the display, wherein the information is at least one image mimicking an exterior environment of the vehicle at the pillar and providing an appearance of the line of sight through the portion of the pillar.

15. The display system of claim 14, wherein the controller is programmed to receive image data from the least one interior camera, the image data indicative of driver behavior.

16. The display system of claim 15, wherein the controller is programmed to classify the driver behavior based on the image data.

17. The display system of claim 16, wherein the controller is further programmed to transmit an alert in response to the driver behavior being classified as distracted.

18. The display system of claim 16, wherein the controller is further programmed to provide a remedial action in response to the driver behavior being classified as distracted.

19. The display system of claim 11, wherein the at least one interior camera is a three-dimensional camera configured to acquire images from multiple perspectives.

20. The display system of claim 11, wherein the at least one interior camera includes at least two, two-dimensional cameras each configured to acquire images from a different plane.
